(19) United States
(12) Patent Application Publication
(10) Pub. No.: US 2015/0023577 A1
(43) Pub. Date: Jan. 22, 2015

(54) DEVICE AND METHOD FOR DETERMINING PHYSIOLOGICAL PARAMETERS BASED ON 3D MEDICAL IMAGES

(71) Applicants: Peng LI, Beijing (CN); HONG'EN (Hangzhou, China) Medical Technology Inc., Zhejiang (CN)

(72) Inventors: Peng Li, Beijing (CN); Xin Yuan, Zhejiang (CN); Gong Chen, Zhejiang (CN)

(73) Assignees: HONG'EN (Hangzhou, China) Medical Technology Inc., Zhejiang (CN); Peng LI, Beijing (CN)

(21) Appl. No.: 14/383,040

(22) PCT Filed: Jan. 30, 2013
(86) PCT No.: PCT/CN2013/071135

§ 371 Date: Sep. 4, 2014

(30) Foreign Application Priority Data
Mar. 5, 2012 (CN) 201210055551.9
Sep. 27, 2012 (CN) 201210374680.4

(51) Int. Cl. G06T 7/60; G06T 7/00

(52) U.S. Cl. CPC G06T 7/602; G06T 7/0012; G06T 7/0085; G06T 2207/10136; G06T 2207/30048
USPC 382/131

(57) ABSTRACT

The invention discloses a device for determining physiological parameters based on 3D medical images. The device comprises: a border determining unit, which is used for determining a border of a target region; and a volume determining unit, which is used for determining the total number of voxels in the target region according to the border determined, and calculating volume of the target region according to a specified relation formula. The invention provides the calculating and processing method and the device with clear physical significance and simple and effective algorithm, and the method and the device are particularly suitable for processing the special situations of the various hearts with pathological changes in clinical art, and can improve the objectivity and accuracy in image data processing.

### FIELD OF THE INVENTION

The invention relates to a method and a device for determining a border of a target region in medical images, as well as determination of physiological parameters by utilizing the determined border of the target region. More specifically, the invention relates to determination of heart physiological parameters based on real ultrasonic image data.

### BACKGROUND OF THE INVENTION

Medical imaging has become an indispensable part of modern medical treatment, and the application of the medical imaging runs through the whole clinical work. The medical imaging is widely used in disease diagnosis, and further plays an important role in the aspects of planning, implementing, and curative effect evaluating of surgeries, radiotherapies and the like. At present, medical images can be grouped into two kinds, namely anatomical images and functional images. The anatomical images mainly describe human body's morphological information including X-ray transmission imaging, CT, MRI, US and so on.

Particularly, in the aspect of modern diagnosis and treatment of heart diseases, quantitative analysis of the medical images by utilizing the computer technology has become an important technical improvement direction. Such method can increase the objectivity of diagnosis, easier to be grasped and operated, and can further reduce the dependence on experience of a reader of the images, thus avoids judgment difference among different readers. Further, in this art, it is desired to obtain quantified physiological parameters of heart, such as ventricular volume, myocardial mass, cardiac chamber wall thickening, heart ejection fraction (EF value) and the like, more accurately based on the image photographing sequence of the heart. Accurate obtainment of the heart ejection fraction has an important significance, since the heart ejection capability can be estimated according to the heart ejection fraction, which is an important parameter for judging the cardiac function.

3D ultrasound is a non-destructive imaging examination technology having advantages of high imaging speed and low cost during detecting the heart diseases, and thus has a widest range of applications in the aspects of diagnosis and treatment of the heart diseases. Analysis of volume of a cardiac chamber, ejection fraction, myocardial volume and mass, and other physiological parameters from a 3D ultrasonic image is an important basis for diagnosis. However, as an echocardiogram contains a lot of noise and the endocardium of the cardiac chamber and the edge of a myocardium are irregular (in particular in the cases of a cardiac chamber and a myocardium with pathological changes), the relevant quantitative calculation thereof becomes difficult. Particularly, how to accurately obtain the endocardial border and how to accurately make calculation regarding a heart with irregular changes are difficult. The art has worked for improving the accuracy and operability in obtaining the physiological parameters from the ultrasonic images.

At present, it is relatively common in clinical use to apply a method for determining a heart ejection fraction (EF value) which includes defining some control points in an interactive way, and modeling the cardiac chamber using a series of simulated geometric shapes, so that the result is very inaccurate.

Many patent publication documents teach adopting the above means. For example, JP2002085404, entitled “ultrasonic imaging processor”, teaches dividing a cardiac chamber into 20 segments to make approximate statistics of the volume thereof. EP123617 teaches using a segmented curve to describe a cardiac chamber. JP2008073423 teaches obtaining an approximate cardiac chamber by interpolation of reference outlines from a set of more than 50 images. EP1998671 (A1) teaches pointing out several control points by utilizing a mouse and matching them with a template, so as to achieve the automatic segmentation. EP2030042 (A1) teaches manually marking a few control points and combining them with a template having being trained, to obtain an endocardium.

In the conventional technologies, it is common to process data by utilizing a prior model, to obtain physiological parameters which are related to the volume of heart, myocardium and the like, which have complex shapes.

The prior model is a model based on statistics, indicates that a data set to be analyzed obeys certain unknown probability distribution and has a definite relationship with the data set of a known sample. In order to achieve the unknown probability distribution, the probability distribution obeyed by the known sample needs to be calculated on the data set of the known sample; and such probability distribution or the distribution parameter, which could be calculated in advance, is called as the prior model.

Generally, compared with a case of the normal cardiac chamber, a heart with the pathological changes is not a cardiac chamber which can be estimated by using the above model any more. The cardiac chamber of the heart with the pathological changes has a shape with unpredictable changes, and the endocardium is also irregular, due to for example, a tumor occupying, a ventricular aneurysm, and the cardiac chamber wall being thickened. The shape changes of the cardiac chamber result in reduction of ejection function, valvular dysfunction and other symptoms.

In the aspect of clinical applications, a prior shape model of the cardiac chamber is obtained by calculation of multiple frames of images in advance, then the prior shape model obtained is contrasted with an approximate geometric model of the cardiac chamber on the current image and further corrected to obtain the cardiac chamber on the current image. However, since such prior model is obtained by calculation according to the normal heart, in the actual clinical application, it is difficult to obtain accurate results when images of a heart with pathological changes are treated by such method.

Please refer to “Convex spatio-temporal segmentation of the endocardium in ultrasound data using distribution and shape priors”, written by Hansson M, Fundana K, Brandt S. S, Gudmundsson P., and published on “Biomedical Imaging: From Nano to Macro”, 2011, Page(s): 626-629. The document proposes making segmentation of a cardiac chamber by a method combining machine learning with morphology, particularly, it teaches establishing a probability model by using Rayleigh distribution as the basis, and using the model established to calculate the probability that the current region is inside the cardiac chamber and the probability that the current region is outside the cardiac chamber. Then, such model is trained by processing a lot of ultrasonic image data, to obtain estimated values of various parameters in the probability model. Finally, the probability calculated by the probability model is used as a priori, which is combined with the prior morphological model of the cardiac chamber to segment the central chamber on new images.

Please refer to “A level set approach for shape-driven segmentation and tracking of the left ventricle” written by Paragios N., and published on “Medical Imaging”, 2003, Page(s): 773-776. In the method provided by this document, a level set algorithm is adopted chiefly in a segmentation algorithm of left ventricle, along with using a lot of prior knowledge, i.e., the correct segmentation result of the left ventricle is known. A limitation region and a speed function of the level set are designed by using prior experience combined with the characteristics of the image. Thus, the purpose of segmenting the left ventricle is achieved.

Please refer to “Combining snakes and active shape models for segmenting the human left ventricle in echocardiographic images”, written by Hamarneh G, Gustaysson T., and published on Computers in Cardiology 2000 Digital Object Identifier: 10.1109/CIC.2000.898469 Publication Year: 2000, Page(s): 115-118. A method is proposed by using a snake model to segment the left ventricle. According to the method, a large number of cardiac ultrasonic images including left ventricle should be manually traced by medical experts to achieve a training sample, and then the data are used to define a series of discrete cosine transform coefficients (DCT coefficients). When a new left ventricle image is segmented by the snake algorithm, the discrete cosine transform coefficients of the snake coordinates are initialized, then the discrete cosine transform coefficients from the prior experience are taken as external forces to iterate an active contour till the minimization of energy.

Other relevant patent documents, such as the Chinese patent with the publication number of CN1777898A and the application number of 200480010928.2, entitled “Non-invasive volume determination of left ventricle”, relate to processing of MR images and estimating of LV (left ventricle) volume based on the contour of an endocardium in a 3D image of heart. The contours are manually traced or achieved in a semi-automatic manner. The LV volume is estimated by intensity changes in the region surrounded by the contour. The document teaches marking border points by manually tracing based on the difference between image pixels (namely image gradient), thus such method is likely to be affected by imaging noise and achieve inaccurate results. Further, when the contour determined is directly applied to other time frames, deviations would be introduced even though automatic correction is performed.

As for the conventional technologies for myocardial measurement, a myocardial segmentation method which is more frequently used in clinical use at present is based on the analysis of speckles and texture. This method also includes defining some control points in an interactive manner and obtaining an approximate myocardial contour by curve fitting method, therefore the method also achieves inaccurate results. Similarly, a prior shape model of myocardium is obtained by calculating multiple frames of images in advance, and then it is contrasted with an approximate geometric model of the myocardium on the current image and further corrected to obtain the myocardium on the current image. However, as mentioned above, the prior model is obtained by calculating images of the normal heart, therefore in the actual clinical application, it is also difficult to obtain accurate results when images of a heart with pathological changes are treated by such method.

CN101404931A (application number of CN200780009898.7), entitled “Ultrasonic diagnosis with quantification of myocardial function”, teaches firstly manually setting control points, further connecting the control points by using a curve according to image gradient, and thus achieving the purpose of approximate tracing.

CN101454688A (application number of CN200780018854.0), entitled “Quantification and display of cardiac chamber wall thickening”, discloses a method of achieving distances, changes in wall thickness and strain at specified locations of the myocardium by speckle tracking. No result of the single myocardium is obtained either. The technology determines the endocardial border by using the image gradient. If the image noise is increased, the results become inaccurate. As for the epicardium border, there is no definite gradient, thus, when the epicardium border is determined automatically, dropouts in the border often occur, and the inaccuracy is further caused. Thus, the patent document provides a tool, by which two borders are manually adjusted at the beginning and the end of a cardiac cycle, points which need to be tracked are automatically set between the two borders such that the points are positioned on the myocardium, then the pixels around each point are recorded as speckle patterns, the maximum correlation block matching is performed between the speckle patterns of different frames, and the motion of each point can be tracked. Such speckle tracking is easily to be affected by the noise.

Please refer to a related paper entitiled “Segmentation of the full myocardium in echocardiography using constrained level-sets”, written by Alessandrini, M. Dietenbeck, T. Barbosa, D. D'hooge, J. Basset, O. Speciale, N. Friboulet, D. Bernard, O., and published in Computing in Cardiology. 2010. This paper discloses combination of a traditional level-set method and a prior morphological method, specifically, two attributes namely level-set energy and morphological energy are marked on the points in an image, and two energy attribute values are finally summated in a weighted manner to obtain an energy value of each pixel point. During initialization of the algorithm, six points are manually marked on the image (five points are located on epicardium and one point is located on the endocardium), evolution functions with the value of 0 are respectively established for points on the endocardium and points on the epicardium, then the values of two evolution functions are calculated for all the points on the image, and two evolution curves are respectively obtained. A myocardial layer is segmented.

Please refer to a related paper entitled “Level-set segmentation of myocardium and epicardium in ultrasound images using localized Bhattacharyya distance”, written by Alessandrini, M. Friboulet, D. Basset, O. D'hooge, J. Bernard, O., and published in Ultrasonics Symposium (IUS). 2009. This paper discloses an algorithm which uses Bhattacharyya distance based on Rayleigh distribution as energy constraint of the level-set algorithm during evolution. During initialization of the algorithm, six points are manually marked on the image (five points are located on the epicardium and one point is located on the endocardium), and the evolution functions are respectively established for the points on the endocardium and the points on the epicardium. The myocardial layer is segmented.

Please refer to a related paper entitled “Detection of the whole myocardium in 2D-echocardiography for multiple orientations using a geometrically constrained level-set”, written by T. Dietenbeck, M. Alessandrini, D. Barbosa, J. D'hooge, D. Friboulet, O. Bernard., and published in Medical Image Analysis. 2011. This paper teaches additionally using a thickness factor as an energy constraint of level-set, on the basis of the technical solution taught by the above paper entitled “Segmentation of the Full Myocardiumin Echocardiography Using Constrained Level-Sets”. This method aims at preventing fusion of the evolution curve of the endocardium and the evolution curve of the epicardium, which could occur during the evolution process caused by the same factor. In order to ensure the correct application of the algorithm on images with a short axis, and a long axis etc., before the use of the algorithm, two points should be manually designated to determine the position of tricuspid valve, thereby ensuring the correct execution of the algorithm. The myocardial layer is segmented.

Compared with the normal myocardium, a myocardium with pathological changes has expansionary, shrinkable, hypertrophy and other pathological changes, which finally affect shrinkability, specifically represented as changes in elastic deformation parameters. In the aspect of geometry, compared with the normal myocardium, the myocardium with pathological changes also has differences, and then an irregular border may be produced.

Therefore, in the art, it is urgent to further improve the method of obtaining the heart-related quantified parameters by utilizing image processing, so as to further improve measurement precision and operability of the method.

### SUMMARY OF THE INVENTION

In view of the defects in the prior art, the invention aims at seeking a more effective and accurate image processing and calculating device and a method based on the current medical imaging technology, to improve and enhance the accuracy of physiological parameters which are related to the volume of a cardiac chamber, ejection fraction, myocardial volume and mass, and the like, and further to assist in timely achieving correct diagnosis in clinical treatment process.

The first aspect of the invention provides a device for determining physiological parameters based on 3D medical images. The device comprises: a border determining unit, which is used for determining a border of a target region; and a volume determining unit, which is used for determining the total number of voxels in the target region according to the border determined, and calculating a volume of the target region according to a specified relation formula.

The second aspect of the invention provides a device for determining physiological parameters based on the first aspect, wherein the volume determining unit calculates the volume of the target region with the total number of the voxels and the distances between the voxels as parameters.

The third aspect of the invention provides the device for determining the physiological parameters based on the first or the second aspects, wherein the volume determining unit is set to determine the total number of the voxels in the following way: determining the total number of pixels in a target region in image of each slice, based on two-dimensional border of each slice in a series of slices in a frame of the 3D medical image; and calculating the total number of the voxels of the target region of the frame of the 3D image, based on the total number of the pixels in the target region in the image of each slice.

In the fourth aspect of the invention, the device is further used for determining the volume of the cardiac chamber, wherein the target region is a region of the cardiac chamber, and the volume determining unit carries out the following processing on the images of each slice:

(1) counting a total number of pixels num1 inside an endocardial border;

(2) calculating a weighted value with respect to the number of the pixels on the endocardial border according to gray level gradient, and multiplying the number of the pixels on the endocardial border by the weighted value, so as to obtain a total number of weighted pixels on the endocardial border; and

(3) calculating the volume of the cardiac chamber according to the resolution of the image and the numbers of the pixels which are respectively determined by calculations in the above two items.

The fifth aspect of the invention further provides an EF value calculation unit carrying out the following processing steps: finding a maximum value and a minimum value during each cardiac cycle according to the volume of the cardiac chamber, which is obtained by calculation, and further calculating an EF value.

The sixth aspect of the invention provides the device for determining the physiological parameters based on the fourth aspect, wherein the number of the pixels on the endocardial border is calculated by using the following formula:

$$num 2 = {\sum }_{i = 1}^{N} \frac{{l}_{i}}{{l}_{max} - {l}_{min}}$$

wherein, N is the total number of the pixels on the border, lₘₐₓ is the maximum value of gray level gradient magnitude of the pixels on the border, lₘᵢₙ is the minimum value of the gray level gradient magnitude of the pixels on the border, and lᵢ is the gray level gradient magnitude of each pixel on the border; and

the volume of the cardiac chamber on a frame of the images is calculated by using the following formula:

$$V = ( {\sum }_{i = 1}^{S} ( num {1}_{i} + num {2}_{i} ) ) \times sx \times sy \times sz$$

wherein, S is total number of the slices on the frame of the image, num1ᵢ is the number of the pixels inside the endocardial border on each slice, num2ᵢ is the number of the pixels on the endocardial border on each slice, and sx, sy and sz are distances between the central points of the voxels in x, y and z directions of the frame of the image, and the unit is millimeter (mm).

The seventh aspect of the invention provides the device for determining the physiological parameters based on the sixth aspect, further, the EF value is calculated by using the following formula:

$$EF = \frac{{V}_{max} - {V}_{min}}{{V}_{max}}$$

wherein, the EF value is calculated during each cardiac cycle in an image time sequence, Vₘₐₓ is the maximum value of the volume of the cardiac chamber on each frame of the image during the cardiac cycle, and Vₘᵢₙ is the minimum value of the volume of the cardiac chamber of each frame of the image during the cardiac cycle.

The eighth aspect of the invention provides the device for determining the physiological parameters based on the fourth aspect, the device is used for determining myocardial volume, wherein the volume determining unit carries out the following processing steps on the image of each slice:

(1) counting the number of the pixels num1 inside the border obtained according to a marked myocardial region;

(2) obtaining a weight value with respect to the pixels on the border according to the gray level gradient, so as to apply to the number of the pixels on the border; and

(3) calculating the myocardial volume according to the resolution of the image and the number of the pixels determined in the above two items.

The ninth aspect of the invention provides the device for determining the physiological parameters based on the fourth aspect, wherein the unit myocardial volume is calculated by using the following formula:

$$num 2 = {\sum }_{i = 1}^{N} \frac{{l}_{i}}{{l}_{max} - {l}_{min}}$$

wherein, S is a total number of the slices on the frame of the image, num1ᵢ is the number of the pixels inside the respective myocardial border on each slice, num2ᵢ is the number of the pixels on the unit myocardial border on each slice, and sx, sy and sz are distances between the central points of the voxels in x, y and z directions of the frame of the image, and the unit is millimeter (mm).

The tenth aspect of the invention provides the device based on the eighth or the ninth aspects, which further provides a myocardial mass calculation unit which carrying out the following processing steps:

calculating myocardial mass according to the density obtained by clinical trials.

The eleventh aspect of the invention provides the device based on the above aspects, wherein the border determining unit differentiates the border of the target region according to the physical quantitative properties reflected by tissue distribution in the medical image, and the device comprises:

an interactive unit, by which an operator can select the target region on the medical image;

a threshold setting unit, which determines threshold values of the physical quantitative properties in the target region selected; and

a threshold segmentation unit, which segments a region to be analyzed, at least containing part of the target region, into sub-regions; and compares the average parameter values of the physical quantitative properties of each sub-region with the threshold values, and marks each of the sub-regions according to comparison results.

The twelfth aspect of the invention provides the device based on the above aspects, wherein the physiological parameters to be determined are selected from: volume of each cardiac chamber, a total volume of the cardiac chambers, a heart ejection fraction, myocardial volume and myocardial mass.

The thirteenth aspect of the invention provides a physiological parameter quantitative calculation method based 3D medical images, comprising the following steps:

determining a border of a target region; and

determining the total number of voxels of the target region according to the border determined, and calculating the volume of the target region according to a specified relation formula.

The fourteenth aspect of the invention provides the physiological parameter quantitative calculation, which further comprises: calculating the volume of the target region with the total number of the voxels and the distances between the voxels as parameters.

Another aspect of the invention is based on the physiological parameter quantitative calculation method in the above aspects, wherein the method further comprises differentiating the border of the target region according to the physical quantitative properties reflected by tissue distribution in the medical image, and includes the following steps:
selecting the target region,
setting threshold values of the physical quantitative properties in the target region,
segmenting the region to be analyzed, at least containing part of the target region, into sub-regions, and
comparing the average parameter values of the physical quantitative properties of each sub-region with the threshold values, and marking each of the sub-regions according to comparison results.

The key point of the invention is that, the total number of the voxels of the target region is determined according to the border of the target region obtained according to the medical image, and the volume of the target region is further calculated based on the total number of the voxels according to the specified relation formula.

The object of the invention is to provide an intuitive and practical solution for solving the problems. The inventor notices that, as the heart, in particular the heart with pathological changes, not only has a very complex shape, but also relates to many irregular changes. On the other hand, in the present field, it is common to calculate the volume of cardiac chamber and myocardium, and an ejection parameter (EF) obtained based on the volume of the cardiac chamber with the help of a prior model or a simulated approximate method in the art, for example, a method of converting the volume calculation of the cardiac chamber to the volume calculation of a cone, so that the complex calculation processing could be avoided. However, the above modeling method is not suitable for the heart with pathological changes, so further improvement is still desired for clinical application.

Therefore, according to the invention, the total number of the voxels of the target tissue is determined based on an accurate 3D border obtained; and further, the total number of the voxels and the distances between the central points of the voxels are directly used as the parameters for obtaining the physiological parameters, such as the volume of the cardiac chamber, the heart ejection parameter, the myocardial weight and the like. The more intuitive explanation is that, the one could directly fills a container with liquid and then pours the liquid into a measuring cup to determine the volume of the container, rather than performing complex calculation from the perspective of geometry, based on the inspiration of volume calculation against the complex container.

Based on the above idea, similarly, the inventor combines the resolution characteristic of an imaging device with the computer technology, and the difficult problems in the art can be unexpectedly solved in a simple and clear way from the direction which is never considered in the art. The invention is more suitable for accurately determining the relevant parameters of the heart with pathological changes, is more targeted in clinical application and can further improve the accuracy and reliability of measurement.

The invention further provides a more specific heart-related physiological parameter calculation method, which is effective in calculating of the volume of the cardiac chamber, the heart ejection parameter, the myocardial weight and the like.

Based on the above aspects, the invention further results in advantages. In the aspect of quantifying the heart physiological parameters based on image processing, generally, only left ventricle is researched in the art, and the “ejection fraction” of the heart typically refers to the capability of the left ventricle ejecting blood into aorta, thereby representing the cardiac function. However, those skilled in the art are easy to understand that changes in function of other cardiac chambers will certainly also affect the EF value—the cardiac function. Actually, in the general situation, only the left ventricle is researched, because calculations relating to shapes and the volume of other ventricles involve more factors which would cause difficulty in calculation. However, due to the complexity and precision of the heart, for clinical medicine, it is very important to grasp more comprehensive data of different ventricles and cardiac chambers. The image processing method and the device of the present invention not only can effectively obtain the border, the volume and the ejection fraction of the left ventricle, but also are suitable for various ventricles, cardiac chambers and myocardium.

The solution of the invention for solving the problems provides a calculating and processing method and a device with clear physical significance and simple and effective algorithm, and the method and the device are particularly suitable for processing the special situations of various hearts with pathological changes in clinical art, and can improve the objectivity and accuracy in image data processing. Thus, the present invention has important application value and improvement for medical image processing technologies, in particular to cardiac image processing.

In addition, the above aspects of the invention can also be combined with other more effective target region defining device and method of the invention, so as to obtain the better technical effects. Specifically, the present invention further relates to: setting threshold values of parameters with respect to quantitative characteristic of a typical region in the target region, such as a partial region at the middle part of the target region, based on the quantitative characteristic reflected in the image by a physical nature of tissue distribution of an imaging object; determining results of comparing the threshold values with each of the sub-regions through the thresholding segmentation method, then grouping all the sub-regions into two types so as to differentiate the border of the target region on the image.

Preferably, the gray level of pixels or voxels is used as the quantitative characteristic. The average gray level is a characteristic measurement way with relatively high computing speed. In addition, the gradient distribution of the region can also be considered being another simple and efficient way for characteristic measurement.

The object of the above aspects of the present invention is to determine the border of the target region of the medical image by adopting a more accurate and effective method. When the present invention is applied to processing real 3D ultrasonic medical images, more accurate quantified physiological parameters can be obtained. The real 3D ultrasonic medical image refers to a 3D image which is directly generated by a 3D ultrasonic probe. In the ultrasonic 3D image, the determination of the endocardial border or the like has an important significance in the aspect of determining the heart-related physiological parameters.

More specifically, the present invention utilizes the computer technology to extract the border of the interest tissue from the digitized image. The pixels or the voxels around the border of the tissue of interest have an obvious contrast, but the border will become unclear due to the influence of granular noise. The inventor specifically investigates the characteristics of the pixels in the image, and arranges cells or sub-regions in the region to be analyzed, wherein such cells are assumed as “cell filled with pixels”, since it is filled with the inherent pixels for filling the sub-regions at the minimum basic cell. An investigation point is arranged in the region to be analyzed, and a circular or oval sub-region around the point is a cell or “cell filled with pixels”. The sub-regions are mutually overlapped, and the distribution characteristic of pixel values or voxel values in each sub-region is analyzed to deduce a fixed or non-fixed threshold value. Each pixel or voxel in the region around each investigation point is marked according to the threshold value, to obtain the tissue region of interest, and the border thereof is the border of the tissue of interest. The border of the tissue region of interest could be further refined by the following manner: setting investigation points on the tissue region which is well marked by using the designed algorithm again, and further analyzing the distribution discipline of the pixel values or the voxel values with circular or oval regions with different scales or sizes.

Specifically, the present invention relates to a border differentiating way utilizing the computer technology, and includes: selecting a position generally at the center of a region by an operator according to his experience, directly through the characteristics of different regions in relevant images, basing on the fact that physical properties of tissues such as the cardiac chambers and myocardium in the image are different and the fact that the tissue characteristics reflected in the medical image are different; determining the physical properties, such as average value of the gray level, gradient value and the like, of the region by utilizing the computer technology; and comparing the value obtained with the threshold value, so as to differentiate the region and the border as two groups, namely to achieve the effect of binarization of the image, and thus to differentiate the border. This differentiation way is more objective and accurate, since it could avoid the limitation of segmenting the cardiac chamber and the myocardium by using the prior model.

The above description does not intend to limit the present invention to any theoretical limitation, and is only illustrated for enabling those skilled in the art to understand the invention more easily.

Other objects, features, and characteristics of the present invention will become apparent upon the consideration of the following description with reference to the accompanying drawings, all of which form a part of this specification.

### BRIEF DESCRIPTION OF THE DRAWINGS

In order to understand the invention more completely, please refer to the following description and the drawings, in which:

FIG. 1 is a schematic diagram showing result of approximate cardiac chamber segmentation by using an image processing device of a typical conventional technology;

FIG. 2 illustrates that a target cardiac chamber is interactive selected in an embodiment of the invention;

FIG. 3A shows the border of the cardiac chamber, marked by the method of the invention;

FIG. 3B is a schematic diagram of a cardiac chamber volume changing curve of all frames in a time sequence, wherein the maximum volume Vₘₐₓ and the minimum volume Vₘᵢₙ of each frame of the images during each cardiac cycle can be seen from the diagram; and

FIG. 4 is a flow diagram of a specific embodiment of the invention.

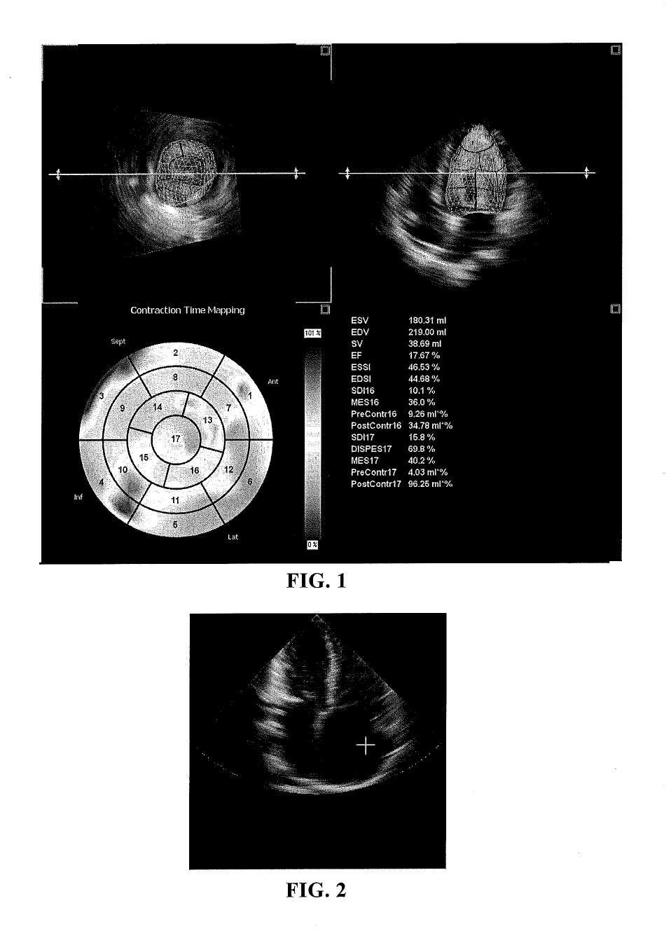

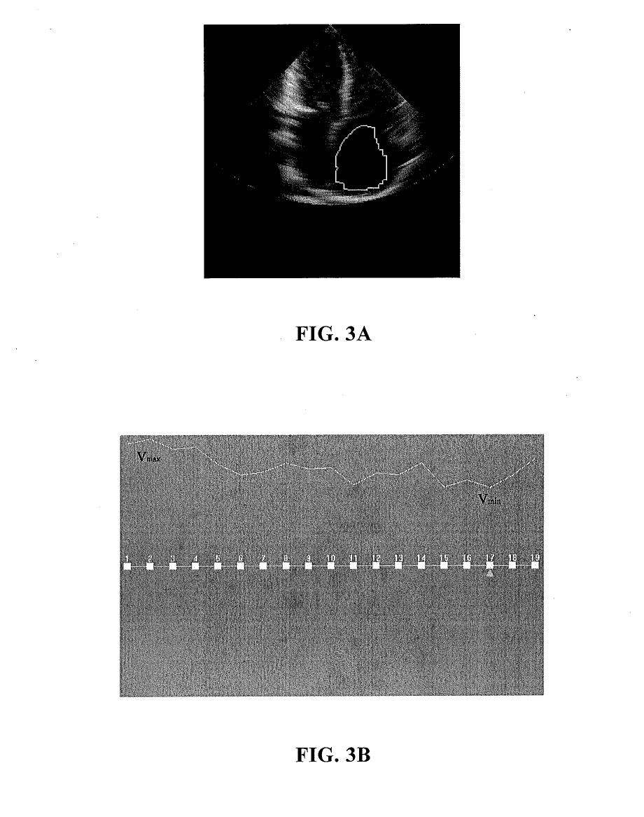

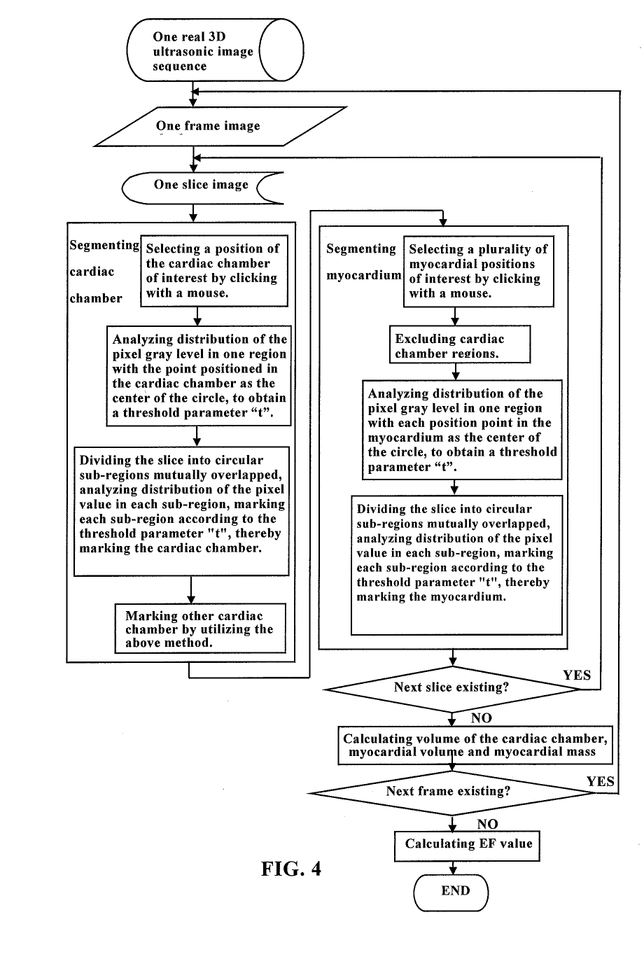

### DETAILED DESCRIPTION OF THE EMBODIMENTS

The border processing regarding a tissue or region (target region) of interest, proposed by the invention, can have a variety of different applications. The description of specific embodiments is provided so as to assist those skilled in the art in understanding the invention, and should not construct any limitation to the present invention.

In the description of the specific embodiments, the analysis is mainly performed by taking pixel gray level as a physical quantitative property. The present invention can also apply other suitable physical quantitative properties.

In one embodiment, the border processing of the invention comprises the following steps.

1. Firstly, a series of slices of a medical image is divided into a series of circular regions which are mutually overlapped, as small sub-regions covering a region to be analyzed, and the regions are defined as cells considered as the cells filled by pixels of the image because the cells are filled with the pixels of the image. The divided circular regions cover the whole slice. The quantitative characteristic is calculated on each circular region according to a pixel gray level value, a threshold value is determined; then all the cells are preliminarily marked according to the threshold value, namely, all the cells are differentiated according to the threshold value.

2. One region or a plurality of communicated regions are obtained by the preliminary marking, the regions of interest (ROI), that is, the target regions, are then integrated for further processing, namely only the communicated region containing the point clicked by a mouse from an operator is maintained, while other regions are discarded, or the other regions are unmarked. Thus, a region resulted by the preliminary segmentation is obtained.

3. After the region resulted from the preliminary segmentation is obtained, a refining treatment is further performed on the border. Firstly, the border of the region after segmentation is marked out independently, then pixel filling cells are arranged on the border, wherein the pixel filling cells are set to cover smaller areas, which can be sized half of the pixel filling cells in the first step, and still need to be mutually overlapped. Similarly, the quantitative characteristic, such as average gray level or gradient and the like, is calculated on the regions, and the threshold value is obtained; then all the pixel filling cells are marked according to the threshold value, and an “or” operation is performed between the marked cells and the region resulted from the preliminary segmentation, so as to obtain a refined region result by merging.

In addition, further refining treatment can be performed, for example:

The operator repeats step 3 according to clinical needs, and the borders can be further refined by further reducing the size of the pixel filling cells till a satisfactory result is obtained.

In addition, a final border refining treatment can be directly performed on three-dimensional data. The so-called three-dimensional data are obtained by accumulating the above slices. Similarly, the obtained borders of the slices are accumulated in the 3D data to represent as a curved surface. Voxel filling cells are arranged on the curved surface, and set the same as in the step 3 which is executed at the last time, namely, the voxel filling cells have the same radius and still need to be mutually overlapped. Similarly, the quantitative characteristics are calculated according to the pixel gray level value on these regions, the threshold value is obtained; then all the pixel filling cells are marked according to the threshold value, and the “or” operation is performed between the marked cells and the region resulted obtained in the step 3 executed at the last time, so as to obtain the refined region results by merging.

As for the processing of the border of a cardiac chamber, it is basically the same as described in the above, except that the following processing needs to be further made in step 2:

(1) The processing steps of preliminary marking in slices are the same as that described above, except that only a gray level average value is observed in the step of selecting a region of the cardiac chamber.

(2) A preliminary segmented region is obtained in combination with the region of interest clicked by the mouse from the operator, and the operation is the same as that will be described later in detail, that is, separating the region containing the point clicked by the mouse independently by using eight communicated adjacent regions.

(3) On the region obtained in step 2, the border is marked out independently, then the border is divided into a series of mutually overlapped circular regions, with the centers of circles being points on the border and the radius of half of the radius of the circular regions in the step 1. The average value of the pixel gray level value and the average value of the pixel gray level gradient magnitude on each circular region are calculated. Two threshold values are obtained by calculating the average values of the values:

Wherein, “n” is the number of the circular regions. Then, the gray level average value and the pixel gradient magnitude average value of each circular region are checked. The gray level average value reflects the average value of gray level average value; the gradient magnitude average value reflects the average value of gradient magnitude average value; the changing amount of the pixels in the region, which reflects the changing amplitude of the pixels in the region, is analyzed as follows, with respect to the border, the amount will become large, while in the case that the amount of a region is smaller than the amount of the border, this region is inside the border and should be marked out, based on the determination condition that the gray level average value of a certain sub-region is smaller than the threshold value of the gray level average value, and the gradient magnitude average value is also smaller than the threshold value of the gradient magnitude average value. Then, the pixels inside the circular region are marked as inside a cardiac chamber region, otherwise, the pixels are marked as belonging to a non-cardiac chamber region. The “or” operation is performed between the cardiac chamber region which is marked out in this step and the cardiac chamber region which is marked out in the step 2, and a refined cardiac chamber region is obtained by merging.

(4) The operator repeats the step 3 according to the clinical needs; in each process, the radius of the circular region which is used currently is half of that of the circular region which was used at the last time, so that the border is further refined till satisfactory results on the 2D slice maps are obtained.

(5) A final refining processing of the border is performed on the frame of the 3D data. The 3D data are formed by accumulating the 2D slices, the cardiac chamber region on each 2D slice is obtained in a step 4, and a 3D region is simultaneously formed by accumulation. The border curved surface of the 3D region is firstly marked out separately, then the border curved surface is divided into a series of spherical regions which are mutually overlapped, with points on the border curved surface as the spherical centers, and the radius the circular region which is used at the last time in the step 4 as the spherical radius. The average value of the voxel gray level value and the average value of the voxel gray level gradient magnitude of each spherical region are calculated. The gray level average value and the gradient magnitude average value of the pixels are obtained by calculating the average values of the values.

Wherein, “n” is the number of the spherical regions. Then, the gray level average value and the gradient magnitude average value of each spherical region are checked, the pixels in the spherical region are marked as inside the cardiac chamber region, and otherwise, the pixels are marked as belonging to a non-cardiac chamber region. The “or” operation is performed between the cardiac chamber region which is marked out in this step and the cardiac chamber region which was marked out in the step 4, and a refined cardiac chamber 3D region is obtained by merging.

### Embodiment 1

The invention is applied to real three-dimensional (3D) ultrasonic image data processing with respect to the heart of a patient, and in the embodiment, the invention is used for obtaining the volume of a cardiac chamber and an ejection fraction.

In Step 1, medical image data of the patient are obtained by utilizing an ultrasonic imaging device. In the embodiment, a real 3D ultrasonic probe is used to scan the region of the heart, then multiple time sequences of a 3D ultrasonic image are obtained, each time sequence contains a series of frames recording one or more complete cardiac cycles, and each frame contains 3D voxel data consisting of multiple slices. The imaging device, such as Siemens SC2000 echocardiographic instrument and Philips IE33, is used.

In Step 2, the contour of the cardiac chamber is extracted from all slice images of all the frames in the real 3D ultrasonic image time sequence. In the specific embodiment, generally, 5-8 time sequences are scanned with respect to one patient, one time sequence has 8-44 frames, one frame has 256 slice images, and the size of each image is of 256*256 pixels.

The extraction of the contour of the cardiac chamber comprises the following steps:

a) In a certain slice image of a certain frame of the real 3D ultrasonic image time sequence, the position of the cardiac chamber of interest is selected by clicking with a mouse, namely a target region is selected.

More specifically, the basis for selecting the slice image is that whether the image contain the cardiac chamber of interest and is exposed most clearly. The mouse-clicking position can be clearly determined by visual inspection, and the position is obviously inside the range of the cardiac chamber.

On the interfaces of all the slices of the certain frame of data, which displays the image time sequence, an operator utilizes the mouse to click on the slices, and the click positions are required to be inside the cardiac chamber of interest. Finally, with the top left corner of the image taken as an origin, the locations in the “x” coordinate and the “y” coordinate of the position point are recorded. In the embodiment, the width direction is taken the “x” axis, and the positive direction is rightward; the height direction is taken as the “y” axis, and the positive direction is downward; and then, the “x” coordinate and the “y” coordinate are obtained. The purpose of setting the coordinates is to describe the spatial position of each pixel or voxel, which is solely determined by coordinates (x, y) or (x, y, z). In calculation, the coordinates are mainly used for judging the adjacency relationship between the pixels or the voxels (there are 8 adjacent regions or 4 adjacent regions in the case of a 2D image, and there are 6 adjacent regions or 26 adjacent regions in the case of a 3D image), so as to determine the range for setting filling cells and marking the cardiac chamber of interest (a communicated adjacency relation is formed between perfusion regions covering the cardiac chamber of interest after being marked, and then a single cardiac chamber can be separated and achieved).

Alternatively, an automatic association processing unit can also be additionally arranged, by which all the slices of the frame of the 3D image can be subject to automatic association processing upon clicking one slice, and merely one slice needs to be clicked for each frame, while other slices can be further processed automatically.

Normally, the range of an ultrasonic image contains the region of interest and the noise (region of non-interest), rather than one kind of region as in an ideal state; and due to the limitation of actual effects, the operator is required to confirm (click) the region of interest as an initial step or “starting” step for implementing the whole process.

b) A circular region is defined, with a point positioned inside the cardiac chamber as the center of the circle and a radius of “r”, the pixel gray level distribution in the region is analyzed and a model parameter (threshold parameter t) is obtained.

More specifically, as the distribution range of the pixel gray level values in the cardiac chamber could not be reflected by the pixels at the point positioned in the cardiac chamber which is clicked with the mouse, and a more accurate estimation of the gray level value distribution can be obtained by utilizing the average value of pixel in an adjacent region around the point. Therefore, when the circular region is defined with the point positioned in the cardiac chamber as the center of the circle and the radius of 5 mm, the average value of the pixel gray level value in the circular region is calculated and set as a model parameter, namely as the threshold parameter “t”, on the basis of the voxel resolution of the 3D ultrasonic image (namely, the distances between the central points of the voxels in the x, y and z directions, with unit of mm) which has been converted into the range of the circular region with cell of pixel.

c) A slice is divided into circular regions which have the radius of “r” and are mutually overlapped, so as to enable the circular regions divided to comprehensively cover the slices. Here, each circular region can be considered as a sub-region of the image filled with pixels. Further, the distribution of the pixel values in each circular region is analyzed, and the cardiac chamber is further marked out by utilizing a threshold segmentation method according to the threshold parameter “t”, namely each circular region is respectively marked either as the cardiac chamber region or as the non-cardiac chamber region.

In the step, threshold segmentation is performed regarding all pixel points of each slice by adopting the threshold value calculated in the step b). As the pixel gray level value inside the region of cardiac chamber is lower, the pixels in the slice map with value smaller than the threshold value need to be marked as inside the cardiac chamber region. In the invention, the slice is firstly divided into a series of circular regions which are mutually overlapped as the sub-regions or pixel filling regions, in which the radius of the circles is 5 mm and the distances between the centers of the circles are also 5 mm; and the range of the circular region taking pixel as cell is obtained by conversion according to the method in the step b). Then, the gray level average value of all the pixels in the region is calculated, if the average value is smaller than the threshold parameter “t”, the pixel points in the circular region are marked as inside the cardiac chamber region, and otherwise, the pixels are marked as belonging to the non-cardiac chamber region. After processing all the circular regions, the is marked map is checked for communicated regions in an 8-adjacent-region way, and the communicated region containing the position point of the cardiac chamber marked out by the operator is taken as the segmentation result of the cardiac chamber of interest. Finally, the same processing of threshold segmentation is performed on all the slices on all the frames of one image time sequence.

In Step 3, the volume of the cardiac chamber and an EF value are calculated according to the cardiac chamber region, which is marked out.

a) Obtaining the endocardial border according to the marked cardiac chamber region.

On the marked cardiac chamber region, each pixel is judged for being an internal point or being a border point by using an adjacent region checking method. If the pixel is a border point, the pixel is marked with white, and pixel points of other kinds are marked with black, so that an irregular endocardial border is obtained.

b) Counting a total number of pixels num1 inside the endocardial border.

c) Calculation a weight value with respect to the pixels on the endocardial border according to the gray level gradient, so as to apply to the number of the pixels on the endocardial border.

The number of the pixels on the endocardial border is achieved by using the following formula:

$$num 2 = {\sum }_{i = 1}^{N} \frac{{l}_{i}}{{l}_{max} - {l}_{min}}$$

wherein, N is the total number of the pixels on the border, lₘₐₓ is the maximum value of gray level gradient magnitude of the pixels on the border, lₘᵢₙ is the minimum value of the gray level gradient magnitude of the pixels on the border, and lᵢ is the gray level gradient magnitude of each pixel on the border.

d) Calculating the volume of the cardiac chamber on a frame of the image by using the following formula:

$$V = ( {\sum }_{i = 1}^{S} ( num {1}_{i} + num {2}_{i} ) ) \times sx \times sy \times sz$$

wherein, S is the total number of the slices on the frame of the image, num1ᵢ is the number of the pixels inside the endocardial border on each slice, num2ᵢ is the number of the pixels on the endocardial border on each slice, and sx, sy and sz are distances between the central points of the voxels in x, y and z directions of the frame of the image, and the unit is mm.

e) Calculating the EF value by using the following formula:

$$EF = \frac{{V}_{max} - {V}_{min}}{{V}_{max}}$$

wherein, the EF value is calculated during each cardiac cycle in an image time sequence, Vₘₐₓ is the maximum value of the volume of the cardiac chamber of each frame of the image during the cardiac cycle, and Vₘᵢₙ is the minimum value of the volume of the cardiac chamber of each frame of the image during the cardiac cycle.

### Embodiment 2

### Calculation of Myocardial Volume and Mass

The step 1 and step 2 of Embodiment 4 are the same as those of Embodiment 1, so that detailed explanation thereof are omitted.

After the step 1 and the step 2 are completed, the step a), the step b) and the step c) in step 2 are repeated to mark out other cardiac chamber regions on the slice, for the step of excluding the cardiac chambers in subsequent myocardial segmentation. Said other cardiac chamber regions refer to the cardiac chambers not completely exposed and unclear, on which similar segmentation operation is performed for the purpose of marking out all the cardiac chambers to avoid affecting the myocardial segmentation. This step is an additional pretreatment step performed before the myocardial segmentation, for the purpose of excluding all the cardiac chambers.

In Step 3, the myocardial contour is extracted from all the slice images of all the frames in the real 3D ultrasonic image time sequence.

a) Selecting a plurality of myocardial positions of interest by clicking with a mouse.

On the interfaces of all the slices of a certain frame of data, which displays the image time sequence, the slice is clicked by the operator utilizes the mouse, and the clicking position is required to be inside the myocardium of interest (target myocardium) and near the edge. Finally, with the top left corner of the image taken as an origin, the locations in the “x” coordinate and the “y” coordinate of the position point are recorded. There may be a plurality of myocardial position points of interest.

b) A circular region is defined with each myocardial position point as the center of a circle and a radius of “r”, the pixel gray level distribution in the region is analyzed and a model parameter (t) is obtained.

As the distribution range of the pixel gray level values in the myocardium could not be reflected by the pixels at the myocardial position point which is clicked with the mouse, and a more accurate estimation of the gray level value distribution can be obtained by utilizing the average value of pixel in an adjacent region around the selected position point. Therefore, when the circular region is defined with the myocardial position point as the center of the circle and the radius of 1 mm, the average value of the pixel gray level value in the circular region is calculated and set as the model parameter, namely as the threshold parameter “t”, on the basis of the voxel resolution of the 3D ultrasonic image (namely, the distances between the central points of the voxels in the x, y and z directions, with unit of mm) which has been converted into the range of the circular region with cell of pixel.

c) The cardiac chamber regions are firstly excluded on the slice, then the slice is further divided into circular regions which have the radius of “r” and are mutually overlapped as cells (pixel filling cells), the distribution of pixel values in each sub-region is analyzed, and the myocardium is marked out by utilizing a threshold segmentation method according to the threshold parameter “t”.

In this step, the threshold segmentation is performed on all the pixel points of the slice according to the threshold parameter “t” which is calculated in the step b, and the pixel points in all the cardiac chamber regions, which are obtained in the step 2 and the additional step, are excluded.

As the pixel gray level value inside the region where the myocardium is located is higher, the pixels in the slice with value larger than the threshold parameter “t” need to be marked as inside the myocardial region.

In the processing, the slice is firstly divided into a series of circular regions which are mutually overlapped, and the circular regions are the pixel filling cells (cells). The radius of the circles is 1 mm, the distances between the centers of the circles are also 1 mm, and the range of the circular regions taking pixel as unit is obtained by conversion according to the method in step b. Then, the gray level average value of all the pixels in the region is calculated, if the average value is larger than the threshold parameter “t”, the pixel points in the circular region are marked as inside the myocardial region, and otherwise, the pixels are marked as belonging to the non-myocardial region. After processing all the circular regions, the marked image is checked for communicated regions in an 8-adjacent-region way, and the communicated region containing the myocardial position point which is marked out by the operator is taken as the segmentation result of the myocardium of interest. Finally, the same processing of threshold segmentation is performed on all the slices on all the frames of one image time sequence.

In Step 4, the myocardial volume and the myocardial mass are calculated according to the myocardial region, which is marked out.

a) Obtaining the borders of the each myocardium according to the each marked myocardial regions.

On the marked myocardial region, each pixel is judged for being an internal point or being a border point by using an adjacent region checking method. If the pixel is a border point, the pixel is marked with white, and pixel points of other kinds are marked with black, so that an irregular myocardial border is obtained.

b) Respectively counting the total number of pixels num1 inside the myocardial border.

c) Respectively calculating a weight value with respect to the pixels on myocardial border according to the gray level gradient, so as to apply to the number of the pixels on the myocardial border.

The number of the pixels on myocardial border is achieved by using the following formula:

$$num 2 = {\sum }_{i = 1}^{N} \frac{{l}_{i}}{{l}_{max} - {l}_{min}}$$

wherein, N is the total number of the pixels on the myocardial border, lₘₐₓ is the maximum value of gray level gradient magnitude of the pixels on the myocardial border, lₘᵢₙ is the minimum value of the gray level gradient magnitude of the pixels on the myocardial border, and lᵢ is the gray level gradient magnitude of each pixel on the myocardial border.

d) Calculating the volume of each myocardium on a frame of the image by using the following formula:

$$V = ( {\sum }_{i = 1}^{S} ( num {1}_{i} + num {2}_{i} ) ) \times sx \times sy \times sz$$

wherein, s is the total number of the slices on the frame of the image, num1ᵢ is the number of the pixels inside unit myocardial border on each slice, num2ᵢ is the number of the pixels on the respective myocardial border on each slice, and sx, sy and sz are distances between the central points of the voxels in x, y and z directions of the frame of the image, and the unit is mm.

e) Calculating the mass of respective myocardium by using the following formula:

m=ρV

wherein: ρ is myocardial average density obtained according to clinical experiments, and V is the volume of the certain myocardium of interest on the frame of the image.

In the above formula for calculating volume, uncertainty of the border voxels during precise tracing of the border is considered, so that the voxels are multiplied by a weighted value before participating in volume accumulation rather than being directly used as a volume element to participate in volume calculation. Therefore, the results obtained could reflect a certain ambiguity of the voxels, and the actual volume of the cardiac chamber or the myocardium can be reflected more accurately.

The volume parameter in the formula for calculating the EF is obtained by using the method of the invention.

The volume parameter in the formula for calculating the myocardial mass is obtained by using the method of the invention.

More specifically, the processing of filling cells provided in the present invention can be performed both on 2D slices and 3D voxel data, and further can be widely used in processing of any high-dimensional data. The geometric shapes of the filling cells are circular in the case of 2D, and pixel intensity data in the circular regions are investigated; and the geometric shapes of the filling sub-regions in the case of 3D are spherical, and voxel intensity data in spheres are investigated. The processing in the case of 2D is preliminary processing, and the processing in the case of 3D is further refining/optimized processing.

In the present invention, the divided adjacent regions are overlapped by adopting a comprehensive coverage principle. The circular regions around each set point are one of the essential factors of the invention. Different shapes can be flexibly used; and the pixel filling region (sub-region) refers to total group of the circular sub-regions around each set point.

A threshold segmentation processing proposed in the present invention is a region-based image segmentation technology, and the basic principle is dividing pixel points of the image into a plurality of categories by setting different characteristic thresholds. The commonly used characteristics comprise: gray level or color characteristic obtained from the original image; and the characteristic obtained by conversion of original gray level or color value. Assuming an original image is set as f(x, y), the characteristic value T is achieved in the f(x, y) according to a certain criterion, the image is segmented into two parts, and the image g(x, y) after segmentation is as follows: if the pixel characteristic value of the f(x, y) is larger than T, the g(x, y) is taken as 0 (black), and otherwise, the g(x, y) is taken as 1 (white), which is commonly known as image binarization. When the pixel characteristic value of the f(x, y) is smaller than T, the g(x, y) is taken as 1, and otherwise, the g(x, y) is taken as 0.

The border processing of the invention can also be applied to processing three-dimensional data, and the operation can refer to the embodiment of two-dimensional processing above. For example, the geometrical shape of the segmentation processing region can be changed from circle to sphere, and the voxels in the sphere are investigated for marking.

The present invention can also be applied to other types of image data processing, such as CT, MRI, PET, SPECT and the like, so as to segment and identify an anatomic tissue of interest and calculate relevant physiological parameters. The anatomic tissue of interest has a certain contrast with the surrounding tissues in the image, is irregular and suitable for segmentation by applying the present invention. The present invention is suitable for not only the case of normal tissues, but also the case of tissue with pathological changes.

Those skilled in the art should understand that, various modification and changes can be made to the preferred embodiments described in the specification without departing from the spirit or the scope of the invention. Thus, the invention comprises various modifications and changes within the scope defined in the attached claims and equivalent thereof.

1. A device for determining physiological parameters based on 3D medical images, comprising:
a border determining unit, which is used for determining a border of a target region; and
a volume determining unit, which is used for determining the total number of voxels in the target region according to the border determined and calculating a volume of the target region according to a specified relation formula.

2. The device for determining the physiological parameters according to claim 1, wherein the volume determining unit calculates the volume of the target region with the total number of the voxels and distances between the voxels as parameters.

3. The device for determining the physiological parameters according to claim 1, wherein,
the volume determining unit is set to determine the total number of the voxels in the following way: determining total number of pixels in a target region in image of each slice, based on two-dimensional border of each slice in a series of slices in a frame of the 3D medical image; and calculating the total number of the voxels of the target region of the frame of the 3D image, based on the total number of the pixels in the target region in the image of each slice.

4. The device for determining the physiological parameters according to claim 3, the device is used for determining volume of a cardiac chamber, wherein the target region is region of the cardiac chamber, and the volume determining unit carries out the following processing steps on the images of each slice:
(1) counting a total number of pixels num1 inside an endocardial border;
(2) calculating a weighted value set with respect to the number of pixels on the endocardial border according to gray level gradient, and multiplying the number of the pixels on the endocardial border by the weighted value, so as to obtain a total number of weighted pixels on the endocardial border; and
(3) calculating the volume of the cardiac chamber according to the resolution of the image and the numbers of the pixels which are respectively determined by calculations in the above two items.

5. The device for determining the physiological parameters according to claim 4, further provides an EF value calculation unit carrying out the following processing steps: finding a maximum value and a minimum value during each cardiac cycle according to the volume of the cardiac chamber, which is obtained by calculation, and further calculating an EF value.

6. The device for determining the physiological parameters according to claim 4, wherein,
the number of the pixels on the endocardial border is calculated by using the following formula:
$$num 2 = {\sum }_{i = 1}^{N} \frac{{l}_{i}}{{l}_{max} - {l}_{min}}$$
wherein, N is the total number of the pixels on the border, lₘₐₓ is the maximum value of gray level gradient magnitude of the pixels on the border, lₘᵢₙ is the minimum value of the gray level gradient magnitude of the pixels on the border, and lᵢ is the gray level gradient magnitude of each pixel on the border; and
the volume of the cardiac chamber on a frame of the images is calculated by using the following formula:
$$V = ( {\sum }_{i = 1}^{S} ( num {1}_{i} + num {2}_{i} ) ) \times sx \times sy \times sz$$
wherein, S is total number of the slices on the frame of the image, num1ᵢ is the number of the pixels inside the endocardial border on each slice, num2ᵢ is the number of the pixels on the endocardial border on each slice, and sx, sy and sz are distances between the central points of the voxels in x, y and z directions of the frame of the image, and the unit is millimeter (mm).

7. The device for determining the physiological parameters according to claim 6, further, the EF value is calculated by using the following formula:
$$EF = \frac{{V}_{max} - {V}_{min}}{{V}_{max}}$$
wherein, the EF value is calculated during each cardiac cycle in an image time sequence, Vₘₐₓ is the maximum value of the volume of the cardiac chamber on each frame of the image during the cardiac cycle, and Vₘᵢₙ is the minimum value of the volume of the cardiac chamber of each frame of the image during the cardiac cycle.

8. The device for determining the physiological parameters according to claim 3, the device is used for determining myocardial volume, wherein the volume determining unit carries out the following processing steps on the image of each slice:
(1) counting the number of the pixels num1 inside the border obtained according to a marked myocardial region;
(2) obtaining a weight value with respect to the pixels on the border according to the gray level gradient, so as to apply to the number of the pixels on the border; and
(3) calculating the myocardial volume according to the resolution of the image and the number of the pixels determined in the above two items.

9. The device for determining the physiological parameters according to claim 8, wherein the unit myocardial volume is calculated by using the following formula:
$$num 2 = {\sum }_{i = 1}^{N} \frac{{l}_{i}}{{l}_{max} - {l}_{min}}$$
wherein, S is a total number of the slices on the frame of the image, num1ᵢ is the number of the pixels inside the respective myocardial border on each slice, num2ᵢ is the number of the pixels on the unit myocardial border on each slice, and sx, sy and sz are distances between the central points of the voxels in x, y and z directions of the frame of the image, and the unit is millimeter (mm).

10. The device for determining the physiological parameters according to claim 8, further providing a myocardial mass calculation unit which carrying out the following processing step:
calculating myocardial mass according to the density obtained by clinical trials.

11. The device for determining the physiological parameters according to claim 1, wherein the border determining unit differentiates the border of the target region according to the physical quantitative properties reflected by tissue distribution in the medical image, and the device comprises:
an interactive unit, by which an operator can select the target region on the medical image;
a threshold setting unit, which determines threshold values of the physical quantitative properties in the target region selected; and
a threshold segmentation unit, which segments a region to be analyzed, at least containing part of the target region, into sub-regions; and compares the average parameter values of the physical quantitative properties of each sub-region with the threshold values, and marks each of the sub-regions according to comparison results.

12. The device according to claim 1, wherein the physiological parameters to be determined are selected from: volume of each cardiac chamber, a total volume of the cardiac chambers, a heart ejection fraction, myocardial volume, and myocardial mass.

13. A physiological parameter quantitative calculation method based 3D medical images, comprising the following steps:
determining a border of a target region; and
determining a total number of voxels in the target region according to the border determined, and calculating a volume of the target region according to a specified relation formula.

14. The physiological parameter quantitative calculation method according to claim 13, further comprising: calculating the volume of the target region with the total number of the voxels and the distances between the voxels as parameters.

15. The physiological parameter quantitative calculation method according to claim 13, wherein, the physiological parameter quantitative calculation method further comprises differentiating the border of the target region according to the physical quantitative properties reflected by tissue distribution in the medical image, and includes the following steps:
selecting the target region,
setting threshold values of the physical quantitative properties in the target region,
segmenting the region to be analyzed, at least containing part of the target region, into sub-regions, and
comparing the average parameter values of the physical quantitative properties of each sub-region with the threshold values, and marking each of the sub-regions according to comparison results.
